(19) United States
(12) Patent Application Publication
(10) Pub. No.: US 2009/0313909 A1
(43) Pub. Date: Dec. 24, 2009

(54) Low density semi-rigid flame resistant foams

(75) Inventors: Jan L. Clatty, Moon Township, PA (US); Alan D. Bushmire, McDonald, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 12/214,569

(22) Filed: Jun. 20, 2008

(51) Int. Cl. C08J 9/06; E06B 3/00; E04B 1/62; E04B 1/92

(52) U.S. Cl. 52/2.11; 521/173; 52/741.3

(57) ABSTRACT

The present invention provides a low density, semi-rigid polyurethane foam made from the reaction product, at an isocyanate index of from about 100 to about 150, of at least one polyisocyanate and an isocyanate-reactive blend containing from about 15 wt. % to about 55 wt. %, based on the weight of the resin, of a difunctional or greater functionality polyether polyol, from about 3 wt. % to about 19 wt. %, based on the weight of the resin, of at least one polyether tetrol, and from about 7 wt. % to about 39 wt. %, based on the weight of the resin, of at least one non-halogenated polyester polyol in the presence of from about 5 wt. % to about 30 wt. %, based on the weight of the resin, of at least one non-hydroxy functional flame retardant and from about 1 wt. % to about 20 wt. %, based on the weight of the resin, of at least one cross linking agent, and optionally in the presence of one or more of catalysts, surfactants, chain extenders and blowing agents, wherein the semi-rigid polyurethane foam having a density of from about 2 to about 25 pcf meets at least a V-1 class rating in accordance with UL 94 V flammability testing. The low density, semi-rigid polyurethane foams of the present invention may find use in producing lightweight, rapidly erected barriers for protection of people such as soldiers, police officers and fire fighters from pursuit by adversaries. Barriers made with the inventive foam may also be used to limit access to already secured areas.

### GOVERNMENT LICENSE RIGHTS

The U.S. Government has a paid-up license in this invention and the right in limited circumstances to require the patent owner to license others on reasonable terms as provided for by the terms of (Grant No. BAA 05-038) awarded by the Defense Advanced Research Projects Agency (“DARPA”).

### FIELD OF THE INVENTION

The present invention relates in general to polyurethane foams, and more specifically, to low density, semi-rigid flame resistant polyurethane foams for potential use in rapidly-formed barriers to assist in protection those such as soldiers, police officers and fire fighters against attack by delaying pursuit of adversaries and by limiting access to already secured areas, as well as assisting and barricading against the threat of natural disasters.

### BACKGROUND OF THE INVENTION

Clark et al., in U.S. Pat. No. 4,589,341, disclose a method of blast suppression that involves forming an expanded foam barrier maintained in position by a barrier element which, in a preferred form, is inflated and maintained in an inflated state by the foam used to form the foam barrier. Clark et al. also provide various barrier structures and methods for suppression of a blast wave.

U.S. Pat. No. 4,836,939, issued to Hendrickson, describes a stable aqueous foam concentrate for use in the generation of an aqueous foam having an expansion ratio of between 10:1 to as high as 1000:1 or more. The concentrate of Hendrickson includes an anionic surfactant material of a chain length of between C₁₂ to C₁₄, a glycol or mixtures thereof, a fatty alcohol of between C₁₂ and C₁₄ chain length and a copolymer of maleic anhydride. The components, other than the polymer are mixed to form a micellar structure and then the polymer is added to react with at least one of the components of at least some of the micelles. Upon foam formation, the polymer which is covalently bound operates to reduce the water drainage rate to increase the foam stability, the foam being biodegradable.

A need exists in (he art for a lightweight barrier that can be rapidly erected which can provide people with at least some protection against enemy attack by delaying pursuit of adversaries and by limiting access to already secured areas, as well as assisting and barricading against the threat of natural disasters.

### SUMMARY OF THE INVENTION

Accordingly, the present invention provides a low density, semi-rigid, flame resistant polyurethane foam which may find use in rapidly-formed barriers for protecting people such as soldiers, police officers and fire fighters from attack by delaying pursuit of adversaries and by limiting access to already secured areas, as well as assisting and barricading against the threat of natural disasters. The inventive low density, semi-rigid polyurethane foam has increased foam flow efficiency with reduced internal blowing pressure, thus allowing it to flow quickly and thoroughly throughout a container, such as a flexible bag, to form a solid barrier.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the FIGURES wherein:

FIG. 1 provides a graph of specific extinction area data from 6 pcf, semi-rigid molded foams with and without flame retardants;

FIG. 2 illustrates a graph of heat release rate date from 6 pcf, semi-rigid molded foams with and without flame retardants;

FIG. 3 shows a graph of foam pressure at room temperature of 6 pcf, semi-rigid molded foams with and without flame retardants;

FIG. 4 illustrates a graph of foam rise height at room temperature of 6 pcf, semi-rigid molded foams with and without flame retardants; and

FIG. 5 provides a graph of foam rise rate at room temperature of 6 pcf, semi-rigid molded foams with and without flame retardants.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a low density, semi-rigid polyurethane foam made from the reaction product, at an isocyanate index of from 100 to 150, of at least one polyisocyanate and an isocyanate-reactive blend containing from 15 wt. % to 55 wt. %, based on the weight of the resin, of a difunctional or greater functionality polyether polyol, from 3 wt. % to 19 wt. %, based on the weight of the resin, of at least one polyether tetrol, and from 7 wt. % to 39 wt. %, based on the weight of the resin, of at least one non-halogenated polyester polyol in the presence of from 5 wt. % to 30 wt. % , based on the weight of the resin, of at least one non-hydroxy functional flame retardant and from 1 wt. % to 20 wt. %, based on the weight of the resin, of at least one cross linking agent, and optionally in the presence of one or more of catalysts, surfactants, chain extenders and blowing agents, wherein the semi-rigid polyurethane foam having a density of from 2 to 25 pcf meets at least a V-l class rating in accordance with UL 94 V flammability testing.

The present invention also provides a rapidly erectable, lightweight barrier comprising a low density, semi-rigid polyurethane foam made from the reaction product, at an isocyanate index of from 100 to 150, of at least one polyisocyanate and an isocyanate-reactive blend containing from 15 wt. % to 55 wt. %, based on the weight of the resin, of a difunctional or greater functionality polyether polyol, from 3 wt. % to 19 wt. %, based on the weight of the resin, of at least one polyether tetrol, and from 7 wt. % to 39 wt. %, based on the weight of the resin, of at least one non-halogenated polyester polyol in the presence of from 5 wt. % to 30 wt. %, based on the weight of the resin, of at least one non-hydroxy functional flame retardant and from I wt. % to 20 wt. %, based on the weight of the resin, of at least one cross linking agent, and optionally in the presence of one or more of catalysts, surfactants, chain extenders and blowing agents, wherein the semi-rigid polyurethane foam having a density of from 2 to 25 pcf meets at least a V-1 class rating in accordance with UL 94 V flammability testing.

The present invention further provides a process for the production of a low density, semi-rigid polyurethane foam involving reacting, at an isocyanate index of from 100 to 150 at least one polyisocyanate and an isocyanate-reactive blend comprising from 15 wt. % to 55 wt. %, based on the weight of the resin, of a difunctional or greater functionality polyether polyol, from 3 wt. % to 19 wt. %, based on the weight of the resin, of at least one polyether tetrol, and from 7 wt. % to 39 wt. %, based on the weight of the resin, of at least one non-halogenated polyester polyol in the presence of from 7 wt. % to 30 wt. %, based on the weight of the resin, of at least one non-hydroxy functional flame retardant and from 1 wt. % to 20 wt. %, based on the weight of the resin, of at least one cross linking agent, and optionally in the presence of one or more of catalysts, surfactants, chain extenders and blowing agents, wherein the low density, semi-rigid polyurethane foam with a density of from 2 to 25 pcf meets at least a V-1 class rating in accordance with UL 94 V flammability testing.

The present invention still further provides a method of delaying pursuit by one or more adversaries, the method involving erecting a barrier made from a low density, semi-rigid polyurethane foam which contains the reaction product, at an isocyanate index of from 100 to 150, of at least one polyisocyanate and an isocyanate-reactive blend comprising from 15 wt. % to 55 wt. %, based on the weight of the resin, of a difunctional or greater functionality polyether polyol, from 3 wt. % to 19 wt. %, based on the weight of the resin, of at least one polyether tetrol, and from 7 wt. % to 39 wt. %, based on the weight of the resin, of at least one non-halogenated polyester polyol, in the presence of from 5 wt. % to 30 wt. %, based on the weight of the resin, of at least one non-hydroxy functional flame retardant and from 1 wt. % to 20 wt. %, based on the weight of the resin, of at least one cross linking agent, and optionally in the presence of one or more of catalysts, surfactants, chain extenders and blowing agents, wherein the semi-rigid polyurethane foam having a density of from 2 to 25 pcf meets at least a V-1 class rating in accordance with UL 94 V flammability testing.

The present invention yet further provides a method of limiting access to a secured area involving erecting one or more barriers made from a low density, semi-rigid polyurethane foam which contains the reaction product, at an isocyanate index of from 100 to 150, of at least one polyisocyanate and an isocyanate-reactive blend comprising from 15 wt. % to 55 wt. %, based on the weight of the resin, of a difunctional or greater functionality polyether polyol, from 3 wt. % to 19 wt. %, based on the weight of the resin, of at least one polyether tetrol, and from 7 wt. % to 39 wt. %, based on the weight of the resin, of at least one non-halogenated polyester polyol, in the presence of from 5 wt. % to 30 wt. %, based on the weight of the resin, of at least one non-hydroxy functional flame retardant and from 1 wt. % to 20 wt. %, based on the weight of the resin, of at least one cross linking agent, and optionally in the presence of one or more of catalysts, surfactants, chain extenders and blowing agents, wherein the semi-rigid polyurethane foam having a density of from 2 to 25 pcf meets at least a V-1 class rating in accordance with UL 94 V flammability testing.

The low density, semi-rigid polyurethane foams according to the invention are prepared by reacting the inventive isocyanate-reactive blend with at least one organic polyisocyanate in the presence of a non-hydroxy functional flame retardant and a cross linking agent.

Suitable polyisocyanates are known to those skilled in the art and include unmodified isocyanates, modified polyisocyanates, and isocyanate prepolymers. Such organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Examples of such isocyanates include those represented by the formula

Q(NCO)ₙ

in which n is a number from 2 to 5, preferably 2 to 3, and Q is an aliphatic hydrocarbon group containing 2 to 18, preferably 6 to 10, carbon atoms; a cycloaliphatic hydrocarbon group containing 4 to 15, preferably 5 to 10, carbon atoms; an araliphatic hydrocarbon group containing 8 to 15, preferably 8 to 13, carbon atoms; or an aromatic hydrocarbon group containing 6 to 15, preferably 6 to 13, carbon atoms.

Examples of suitable isocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; 1-isocyanato-3,3,5-trimethyl-5-isocyanatomethylcyclohexane (isophorone diisocyanate; e.g., German Auslegeschrift 1,202,785 and U.S. Pat. No. 3,401,190); 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (“TDI”); diphenylmethane-2,4′- and/or -4,4′-diisocyanate (“MDI”); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI or polymeric MDI, PMDI), which are described, for example, in GB 878,430 and GB 848,671; norbornane diisocyanates, such as described in U.S. Pat. No. 3,492,330; m- and p-isocyanatophenyl sulfonylisocyanates of the type described in U.S. Pat. No. 3,454,606; perchlorinated aryl polyisocyanates of the type described, for example, in U.S. Pat. No. 3,227,138; modified polyisocyanates containing carbodiimide groups of the type described in U.S. Pat. No. 3,152,162; modified polyisocyanates containing urethane groups of the type described, for example, in U.S. Pat. Nos. 3,394,164 and 3,644,457; modified polyisocyanates containing allophanate groups of the type described, for example, in GB 994,890, BE 761,616, and NL 7,102,524; modified polyisocyanates containing isocyanurate groups of the type described, for example, in U.S. Pat. No. 3,002,973, German Patentschriften 1,022,789, 1,222,067 and 1,027,394, and German Offenlegungsschriften 1,919,034 and 2,004,048; modified polyisocyanates containing urea groups of the type described in German Patentschrift 1,230,778; polyisocyanates containing biuret groups of the type described, for example, in German Patentschrift 1,101,394, U.S. Pat. Nos. 3,124,605 and 3,201,372, and in GB 889,050; polyisocyanates obtained by telomerization reactions of the type described, for example, in U.S. Pat. No. 3,654.106: polyisocyanates containing ester groups of the type described, for example, in GB 965,474 and GB 1,072,956. in U.S. Pat. No. 3,567,763, and in German Patentschrift 1,231,688: reaction products of the above-mentioned isocyanates with acetals as described in German Patentschrift 1,072,385; and polyisocyanates containing polymeric fatty acid groups of the type described in U.S. Pat. No. 3,455,883. It is also possible to use the isocyanate-containing distillation residues accumulating in the production of isocyanates on a commercial scale, optionally in solution in one or more of the polyisocyanates mentioned above.

In general, it is preferred to use readily available polyisocyanates, such as 2,4- and 2,6-toluene diisocyanates and mixtures of these isomers (TDI); polyphenyl-polymethylene-polyisocyanates of the type obtained by condensing aniline with formaldehyde, followed by phosgenation (crude MDI or polymeric MDI, PMDI); and polyisocyanates containing carbodiimide groups, urethane groups, allophanate groups, isocyanurate groups, urea groups, or biuret groups (modified polyisocyanates). Preferred as the polyisocyanate in the low density, semi-rigid foams of the present invention are polymeric MDI or modified polymeric MDI.

Isocyanate-terminated prepolymers may also be employed in the preparation of the foams of the present invention. Prepolymers may be prepared by reacting an excess of organic polyisocyanate or mixtures thereof with a minor amount of an active hydrogen-containing compound as determined by the well-known Zerewitinoff test, as described by Kohler in Journal of the American Chemical Society, 49, 3181(1927). These compounds and their methods of preparation are well known to those skilled in the art. The use of any one specific active hydrogen compound is not critical; any such compound can be employed in the practice of the present invention. Those skilled in the art will recognize that it is also possible to use mixtures of the polyisocyanates described above.

Polyether polyols useful in the isocyanate-reactive blend of present invention include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2 to 8.

A wide variety of initiators may be alkoxylated to form useful polyether polyols. Thus, for example, poly-functional amines and alcohols of the following type may be alkoxylated: monoethanolamine, ethylenediamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Such amines or alcohols may be reacted with the alkylene oxide(s) using techniques known to those skilled in the art. The hydroxyl number which is desired for the finished polyol determines the amount of alkylene oxide used to react with the initiator. The polyether polyol may be prepared by reacting the initiator with a single alkylene oxide, or with two or more alkylene oxides added sequentially to give a block polymer chain, or at once to achieve a random distribution of such alkylene oxides. Polyol blends such as a mixture of high molecular weight polyether polyols with lower molecular weight polyether polyols may also be employed.

The alkylene oxides which may be used in the preparation of the polyol include any compound having acyclic ether group, preferably an α,β-oxirane, and are unsubstituted or alternatively substituted with inert groups which do not chemically react under the conditions encountered in preparing a polyol. Examples of suitable alkylene oxides include ethylene oxide, propylene oxide, 1,2- or 2,3-butylene oxide, the various isomers of hexane oxide, styrene oxide, epichlorohydrin, epoxychlorohexane, epoxychloropentane and the like. Most preferred, on the basis of performance, availability and cost are ethylene oxide, propylene oxide, butylene oxide and mixtures thereof, with ethylene oxide, propylene oxide, or mixtures thereof being most preferred. If polyols are prepared with combinations of alkylene oxides, the alkylene oxides may be reacted as a complete mixture providing a random distribution of oxyalkylene units within the oxide chain of the polyol or alternatively they may be reacted in a step-wise manner so as to provide a block distribution within the oxyalkylene chain of the polyol.

Particularly preferred in the isocyanate-reactive blend of the present invention is from 15% to 55%, more preferably from 11% to 53% by weight of the resin of a difunctional or greater functionality polyether polyol of the kind typically used to produce flexible polyurethane foams. The difunctional or greater functionality polyether polyol may be included in the isocyanate-reactive blend of present invention in an amount ranging between any combination of these values, inclusive of the recited values.

Polyester polyols are also known in the art for imparting good fire performance in foams and are typically used in polyisocyanurate (“PIR”) foams. In polyurethane (“PUR”) foams such polyols are typically used only at fairly low concentrations, along with higher-functional polyether polyols mainly due to their softening effect on polymer properties.

Suitable polyester polyols include polyesters containing from 1.5 to 4.0, preferably 2.0 to 3.0 isocyanate-reactive groups, and having molecular weights of less than 600. Some examples of suitable compounds include, for example, glycols such as, for example, ethylene glycol, propylene glycol, 1,3-propane diol, 1,4-butanediol, 1,6-hexamethylene glycol, dipropylene glycol, tripropylene glycol, diethylene glycol, triethylene glycol, tetraethylene glycol, tetrapropylene glycol, heptapropylene glycol, neopentyl glycol, 2,2,4-trimethyl-1,5-pentanediol, etc. Also suitable compounds include, for example, diamines, triamines, and aminoalcohols such as ethylene diamine, toluene diamine, diethylenetriamine, ammonia, aminoalcohols which can be prepared by the alkoxylation of ammonia, 2,4′-, 2,2′- and 4,4′-methylene dianiline, 2,6- and/or 2,4-toluene diamine and vicinal toluene diamines, p-aminoaniline, 1,5-diaminonaphthalene, mixtures of methylene dianiline and its higher homologs, ethylene diamine, propylene diamine, diethylene triamine, 1,3-diaminopropane, 1,3-diaminobutane and 1,4-diaminobutane, ethanolamine, diethanolamine, and aminoethylethanolamine. Ethylene diamine and toluene diamines are particularly preferred. Polyesters are obtained from the glycols above, preferably dihydric alcohols to which trillydric alcohols may be added and polybasic, preferably dibasic carboxylic acids. Instead of these polycarboxylic acids, the corresponding carboxylic acid anhydrides or polycarboxylic acid esters of lower alcohols or mixtures thereof may be used for preparing the polyesters. The polycarboxylic acids may be aliphatic, cycloaliphatic, aromatic and/or heterocyclic and they may be unsaturated and/or substituted, e.g. by halogen atoms. Examples of these acids include succinic acid, adipic acid, suberic acid, azelaic acid, sebacic acid, phthalic acid, isophthalic acid, trimellitic acid, phthalic acid anhydride, tetrahydropthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, dimeric and trimeric fatty acids such as oleic acid (which may be mixed with monomelic fatty acids), dimethyl terephthalate and bis-glycol terephthalate. These low molecular weight polyols also include compounds such as, for example, cyclohexane-dimethanol and the diverse bisphenols.

Suitable and more preferred aromatic polyester polyols for use in the inventive isocyanate-reactive blend include those prepared by reacting a polycarboxylic acid and/or a derivative thereof or an anhydride with a polyhydric alcohol, wherein at least one of these reactants is aromatic. The polycarboxylic acids may be any of the known aliphatic, cycloaliphatic, aromatic, and/or heterocyclic polycarboxylic acids and may be substituted, (e.g., with halogen atoms) and/or unsaturated. Examples of suitable polycarboxylic acids and anhydrides and extracts thereof are as noted above.

Suitable aromatic polycarboxylic acid derivatives are: dimethyl or diethyl esters of polycarboxylic acids such as phthalic acid, isophthalic acid, terephthalic acid and trimellitic acid. Examples of suitable aromatic anhydrides are phthalic anhydride, tetrahydrophthalic anhydride, and pyromellitic anhydride.

The polyhydric alcohols suitable for the preparation of polyester polyols may be aliphatic, cycloaliphatic, aromatic, and/or heterocyclic. The polyhydric alcohols optionally may include substituents which are inert in the reaction, for example, chlorine and bromine substituents, and/or may be unsaturated. Suitable amino alcohols, such as monoethanolamine, diethanolamine or the like may also be used. Examples of suitable polyhydric alcohols include ethylene glycol, propylene, glycol, polyoxyalkylene glycols (such as diethylene glycol, polyethylene glycol, dipropylene glycol and polypropylene glycol), glycerol and trimethylolpropane. Examples of suitable aromatic polyhydric alcohols are 1,4-benzene diol, hydroquinone di(2-hydroxyethyl)ether, bis(hydroxyethyl)terephthalate, and resorcinol.

There are many polyester polyols available from a variety of suppliers such as Stepan, INVISTA, OXID and others. Particularly preferred in the isocyanate-reactive blend of the present invention are polyester polyols included in amounts of from 7 wt. % to 39 wt. %, and more preferably from 7 wt. % to 21 wt. % by weight in the resin blend. The aromatic polyester polyol is preferably non-halogenated. The aromatic pqlyester polyol may be included in the isocyanate-reactive blend of present invention in an amount ranging between any combination of these values, inclusive of the recited values.

The isocyanate-reactive blend particularly preferred for producing the low density, semi-rigid foams of the present invention contains a non-halogenated aromatic polyester polyol, a difunctional or greater functionality polyether polyol and a polyether tetrol.

Suitable non-hydroxy functional flame retardants, include phosphonates, phosphites, and phosphates (such as dimethyl methylphosphonate, ammonium polyphosphate, and various cyclic phosphate and phosphonate esters), halogen-containing compounds known in the art (such as tri(β-chloroisopropyl)phosphate and other brominated aromatic and aliphatic compounds); melamine; antimony oxides (such as antimony pentoxide and antimony trioxide); zinc compounds (such as various known zinc borates); aluminum compounds (such as alumina trihydrate); magnesium compounds (such as magnesium hydroxide); expanded graphite, and urea, as well as, reactive oligomeric organophosphates having functionality greater than one, known to those skilled in the art); halogen-containing compounds known in the art (such as diester/ether diol of tetrabromophthalic anhydride and other brominated aromatic and aliphatic compounds). Particularly preferred in producing the semi-rigid foams of the present invention is the inclusion of the non-hydroxy functional flame retardant in an amount of from of 5 wt. % to 30 wt. %, more preferably from 5 wt. % to 20 wt. %, based on the weight of the resin. The non-hydroxy functional flame retardant may be included in the semi-rigid foams of the present, invention in an amount ranging between any combination of these values, inclusive or the recited values. Surprisingly, although non reactive flame retardant(s) are included, the other physical properties desired from the semi-rigid polyurethane foam are not destroyed as such flame retardants are known, and expected, to do. Foam physical performance is maintained along with the addition of a flame retardant and the semi-rigid polyurethane foam performed well at an extremely low molded density and thickness.

Suitable catalysts include tertiary amines and metal compounds known to those skilled in the art. Suitable tertiary amine catalysts include triethylamine, tributylamine, triethylene diamine, N-methylmorpholine, N-ethylmorpholine, N,N,N′,N′-tetramethylethylene diamine, pentamethyldiethylene triamine, and higher homologs, 1,4-diazabicyclo[2.2.2]octane, N-methyl-N′-(dimethylamino-ethyl)-piperazine, bis(dimethylaminoalkyl)piperazines, N,N-dimethylbenzylamine, N,N-dimethylcyclohexylamine, N,N-diethylbenzylamine, bis(N,N-diethylaminoethyl)adipate, N,N,N′,N′-tetramethyl-1,3-butanediamine, N,N-dimethyl-β-phenylethylamine, amine salt of diazabicyclounclecene and formic acid, 1,2-dimethylimidazole, 2-methylimidazole, monocyclic and bicyclic amidines, bis(dialkylamino)alkyl ethers (U.S. Pat. No. 3,330,782), and tertiary amines containing amide groups (preferably formamide groups). The catalysts used may also be the known Mannich bases of secondary amines (such as dimethylamine) and aldehydes (preferably formaldehyde) or ketones (such as acetone) and phenols.

Suitable catalysts also include certain tertiary amines containing isocyanate-reactive hydrogen atoms. Examples of such catalysts include triethanolamine, triisopropanolamine, N-methyldiethanolamine, N-ethyl-diethanolamine, N,N-dimethylethanolamine, their reaction products with alkylene oxides (such as propylene oxide and/or ethylene oxide) and secondary-tertiary amines.

Other suitable catalysts include organic metal compounds, especially organic tin, bismuth, and zinc compounds. Suitable organic tin compounds include those containing sulfur, such as dioctyl tin mercaptide and, preferably, tin(II) salts of carboxylic acids, such as tin(II) acetate, tin(II) octoate, tin(II) ethylhexoate, and tin(II) laurate, as well as tin(IV) compounds, such as dibutyltin dilaurate, dibutyltin dichloride, dibutyltin diacetate, dibutytin maleate, and dioctyltin diacetate. Suitable bismuth compounds include bismuth neodecanoate, bismuth versalate, and various bismuth carboxylates known in the art. Suitable zinc compounds include zinc neodecanoate and zinc versalate. Mixed metal salts containing more than one metal (such as carboxylic acid salts containing both zinc and bismuth) are also suitable catalysts. Any of the above-mentioned catalysts may, of course, be used as mixtures. Suitable catalyst mixtures may be found in U.S. Pat. No. 5,401,824.

The catalyst(s) may be included in the isocyanate-reactive blend in an amount preferably such that the catalyst(s) chosen produce the desired reactivity profile based on the chosen volume of blowing agent used.

It may be advantageous to employ a minor amount of a surfactant and/or compatibilizing agent to stabilize the foaming reaction mixture until it obtains rigidity. Any suitable surfactant can be employed in the invention, including silicone/ethylene oxide/propylene oxide copolymers. Examples of surfactants useful in the present invention include those available from manufacturers such as GE Silicones, Air Products and Chemicals and Goldschmidt Chemical Corporation. Other suitable surfactants and compatibilizing agents are described in U.S. Pat. Nos. 4,365,024, 4,529,745 and 3,726,952. Other, less preferred surfactants include polyethylene glycol ethers of long chain alcohols, tertiary amine or alkanolamine salts of long chain alkyl acid sulfate esters, alkylsulfonic esters, alkylarylsulfonic acids. Such surfactants are employed in amounts sufficient to stabilize the foaming reaction mixture against collapse and the formation of large and uneven cells. The surfactant may be included in the polyol component in an amount of from 0.05% to 10%, and preferably from 0.1% to 6%, weight percent of the polyol resin blend component. The surfactant may be included in the present invention in an amount ranging between any combination of these values, inclusive of the recited values.

Suitable crosslinking agents or chain extenders which may be included in the present invention generally have a molecular weight of less than 399 and a functionality of from about 2 to about 6 (preferably 2 to 4). Chain extenders generally have a functionality of about 2 and crosslinking agents generally have a functionality of 2 or greater. Such compounds typically contain hydroxyl groups, amino groups, thiol groups, or a combination thereof, and generally contain 2 to 8 (preferably 2 to 4) isocyanate-reactive hydrogen atoms.

The preferred hydroxyl-containing chain extenders and crosslinking agents include glycols and polyols, such as 1,2-ethanediol, 1,2- and 1,3-propylene glycol, 1,4- and 2,3-butylene glycol, 1,6-hexanediol, 1,8-octanediol, neopentyl glycol, cyclohexane-dimethanol, 1-methyl-1,3-propanediol, 2-methyl- 1,3-propanediol, glycerol, trimethylol-propane, 1,2,6-hexanetriol, pentaerythritol, 1,2,4-butanetriol, and trimethylolethane and ethylenediamine. Such amines or alcohols may be reacted with the alkylene oxide(s) using techniques known to those skilled in the art. The hydroxyl number which is desired for the finished polyol determines the amount of alkylene oxide used to react with the initiator. The polyether polyol may be prepared by reacting the initiator with a single alkylene oxide, or with two or more alkylene oxides added sequentially to give a block polymer chain, or at once to achieve a random distribution of such alkylene oxides. In the foams of present invention, a crosslinking agent is included preferably in a range from 1 wt. % to 20 wt. %, more preferably from 5 wt. % to 15 wt. %, based on the weight of the resin. The crosslinking agents may be present in the present invention in an amount ranging between any combination of these values, inclusive of the recited values.

Suitable chain extenders also include hydroxyl-containing polyethers having a molecular weight of less than 399. Suitable hydroxyl-containing polyethers can be prepared, for example, by the methods discussed above for the higher molecular weight hydroxy-containing polyethers except that only lower molecular weight polyethers are used. Glycerol which has been propoxylated and/or ethoxylated to produce a polyol having a molecular weight of less than 399 is an example. Particularly suitable polyethers include polyoxyalkylene polyether polyols, such as polyoxyethylene diol, polyoxypropylene diol, polyoxybutylene diol, and polytetramethylene diol having the requisite molecular weights.

Suitable blowing agents for use in the preparation of polyurethane foams include water and/or readily volatile organic substances. Organic blowing agents include acetone, ethyl acetate, methanol, ethanol, low-bowling hydrocarbons (such as butane, hexane, or heptane) or fluorocarbons, chlorofluorocarbons, hydrochlorofluorocarbons, or other halogen-substituted alkanes (such as methylene chloride, chloroform, ethyl idene chloride, vinyl idene chloride, monofluorotrichloromethane, chlorodifluoroethane, and dichlorodifluoromethane), diethylether, or carboxylic acids (such as lactic acid, citric acid, and malonic acid), as well as carbon dioxide generated by the hydrolysis of isocyanate groups. A blowing effect may also be obtained by adding compounds which decompose at temperatures above room temperature and thereby give off gases such as nitrogen (for example, azo compounds such as azoisobutyronitrile or carbon dioxide (such as dimethyl dicarbonate). Mixtures of these blowing agents may also prove useful.

It is preferred, due to the Montreal Protocol restrictions and other pending restrictions, that a foam that is solely water-, or carbon dioxide-blown be used. The isocyanate and polyol component are preferably reacted in the presence of water and/or carbon dioxide. More preferably, water alone is used as the blowing agent, which by reaction with isocyanate groups, delivers carbon dioxide as fuel gas. In addition to water, carbon dioxide, particularly in liquid form, may be added. The blowing agent is preferably included in the polyol component in an amount of from 0.12 wt. % to 3 wt. %, more preferably from 0.2 wt. % to 1.5 wt. %, based on weight of the resin.

The catalyst(s) may be included and adjusted in the polyol component in an amount preferably such that the catalyst(s) chosen produce the desired reactivity profile based on the chosen volume of blowing agent used.

When carrying out the reaction of-the isocyanate-reactive blend with the polyisocyanate, the quantity of the polyisocyanate should preferably be such that the isocyanate index is from 100 to 150, more preferably from 110 to 120. The isocyanate index of the foams of the present invention may range between any combination of these values, inclusive of the recited values. By “isocyanate index” is meant the quotient of the number of isocyanate groups divided by the number of isocyanate-reactive groups, multiplied by 100.

By the term “low density”, the present inventors mean that the semi-rigid foams preferably have a density of from 2 pcf to 25 pcf, more preferably, from 4 pcf to 20 pcf, and most preferably from 6 pcf to 20 pcf. The foams of the present invention preferably have a thickness of from 0.25 inch to 2 inches, more preferably from 0.5 inch to 1 inch. The foams of the present invention may find use in providing rapidly erected, lightweight barriers for the protection of those such as soldiers, police officers and fire fighters from attack by delaying pursuit of adversaries and/or flames and by limiting access to already secured areas. The inventive foams may also find use in providing barricades against the threat of natural disaster.

### EXAMPLES

The present invention is further illustrated, but is not to be limited, by the following examples. All quantities given in “parts” and “percents” are understood to be by weight, unless otherwise indicated. The following materials were used in producing the semi-rigid polyurethane foams of the examples:

| | |
|---|---|
| POLYOL A | 4,800-molecular weight polyoxypropylene triol |
| | modified with ethylene oxide; having a functionality |
| | of about 3, a hydroxyl number of about 35 mg |
| | KOH/g; |
| POLYOL B | a 4,000 molecular weight propylene oxide/ethylene |
| | oxide polyether polyol based on propylene glycol, |
| | (80 wt. % PO/20 wt. % EO end block), having a |
| | hydroxyl number of about 28 mg KOH/g and a |
| | functionality of about 1.82; |
| POLYOL C | an aromatic polyester polyol having a hydroxyl |
| | number of 175-195, available from Oxid as TEROL |
| | 198; |
| FLAME | tri(β-chloroisopropyl)phosphate, available from |
| RETARDANT A | Akzo Chemicals, Inc.; |
| FLAME | dimethylmethyl phosphonate, available from Akzo |
| RETARDANT B | Chemicals, Inc.; |
| SURFACTANT | a polyether-silicone copolymer available as NIAX |
| | L-5309; |
| CATALYST A | dibutyltin mercaptide available from GE Silicones |
| | as FOMREZ UL-1; |
| CATALYST B | bis[2-dimethylaminoethyl]ether available from GE |
| | Silicones as NIAX A-1: |
| BLOWING AGENT | 2-hydroxypropanoic acid, available from Sterling |
| | Chemicals Inc.; |
| COMPATIBILIZER | the reaction product of N,N-dimethylpropylene |
| | diamine with tall oil: |
| CHAIN | ethylene glycol; |
| EXTENDER | |
| CROSS LINKING | a polyether tetrol available from SEPPIC Inc., as |
| AGENT | SIMULSOL PTNP having a hydroxyl number of |
| | ~340-380; |
| ISOCYANATE A | a mixture of equal parts by weight of a liquid semi- |
| | prepolymer (NCO about 23%) prepared by the |
| | reaction of 4,4′-diphenylmethane diisocyanate and |
| | tripropylene glycol in a molar ratio of about 5:1 and |
| | an aniline - formaldehyde condensation product |
| | (average functionality about 2.8) containing about |
| | 44% monomeric 4,4′ diphenylmethane diisocyanate |
| | (the balance being essentially higher functionality |
| | homologs); and |
| ISOCYANATE B | a polymeric diphenylmethane diisocyanate having |
| | an NCO group content of about 31.5%, a |
| | functionality of about 2.8, and a viscosity of about |
| | 196 mPa · s at 25° C. |

### Examples 1-5

The components were combined in the amounts given in Table I below and reacted at an isocyanate index of 120 to produce foam samples having a molded density of 6 pcf.

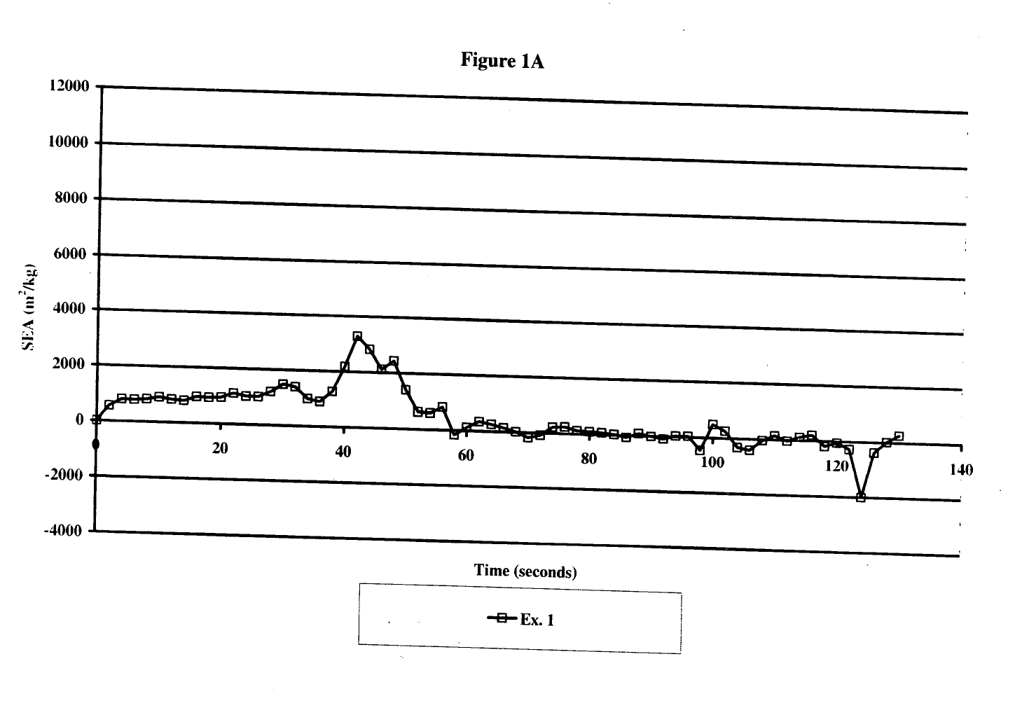

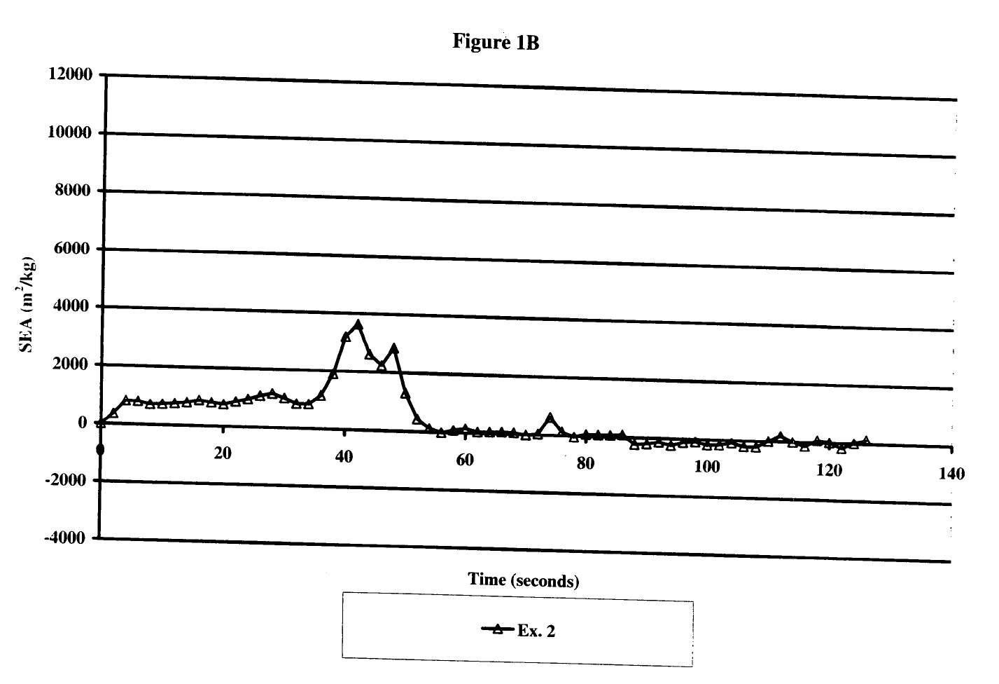

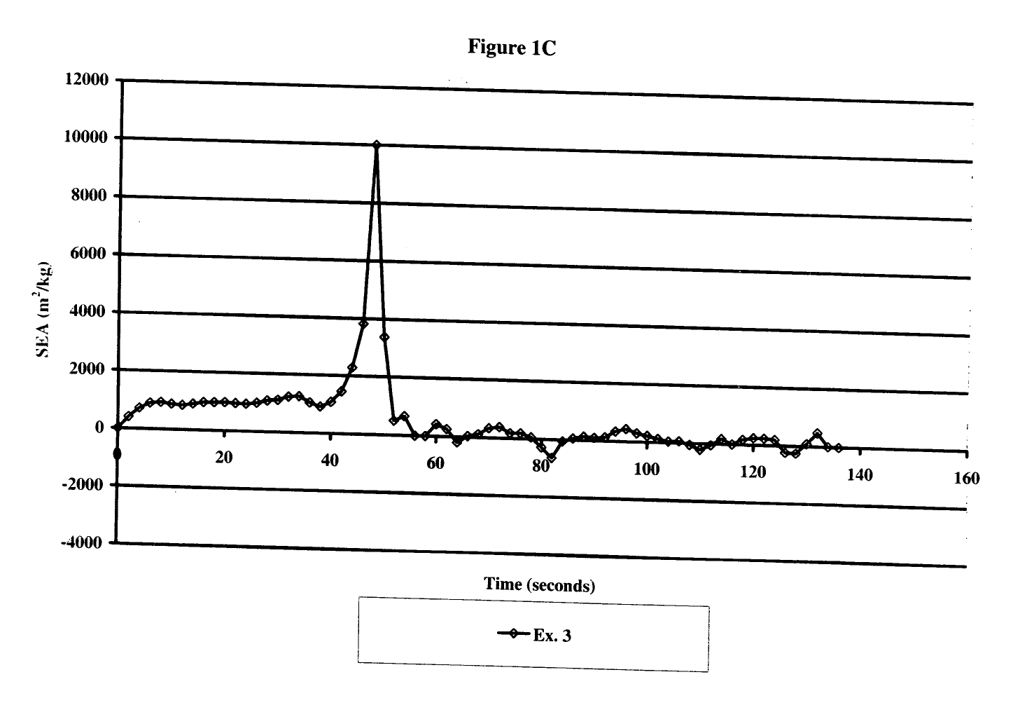

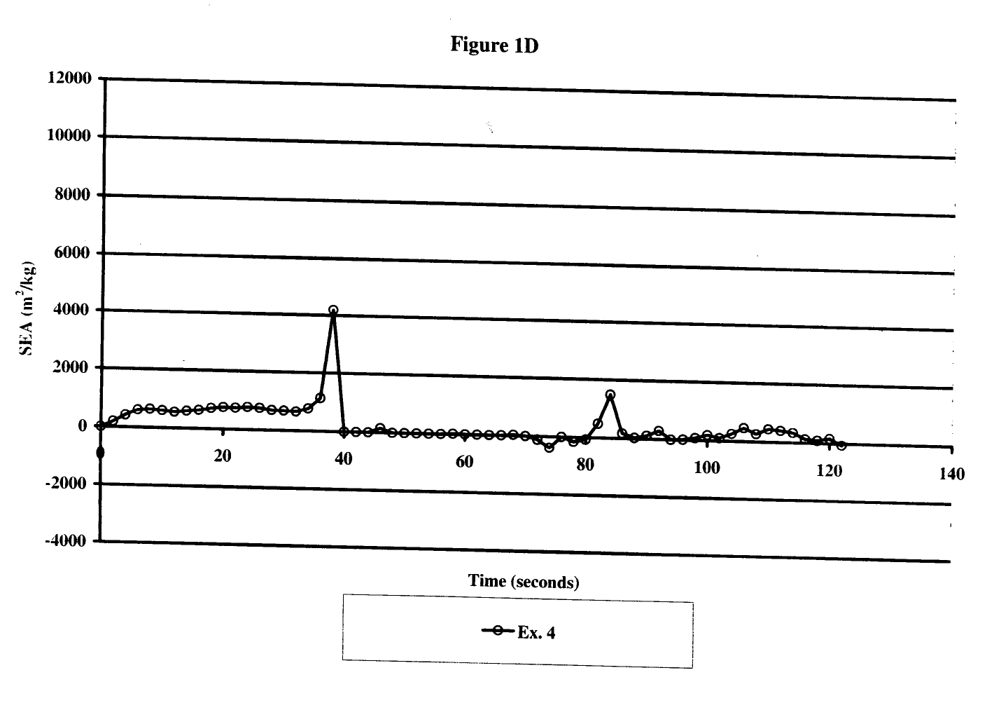

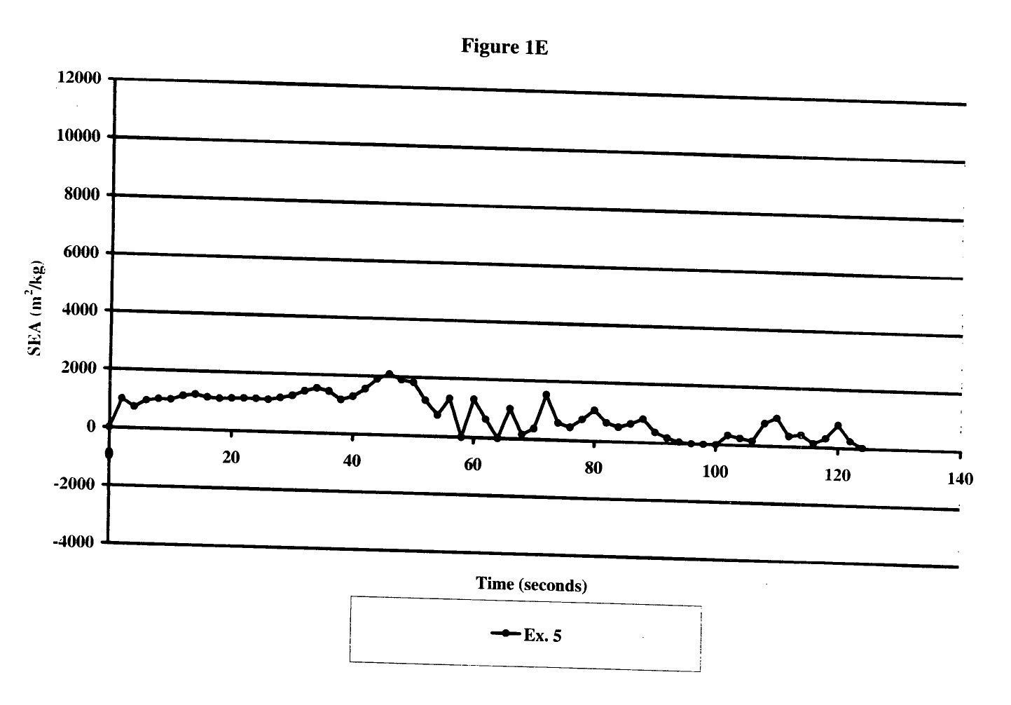

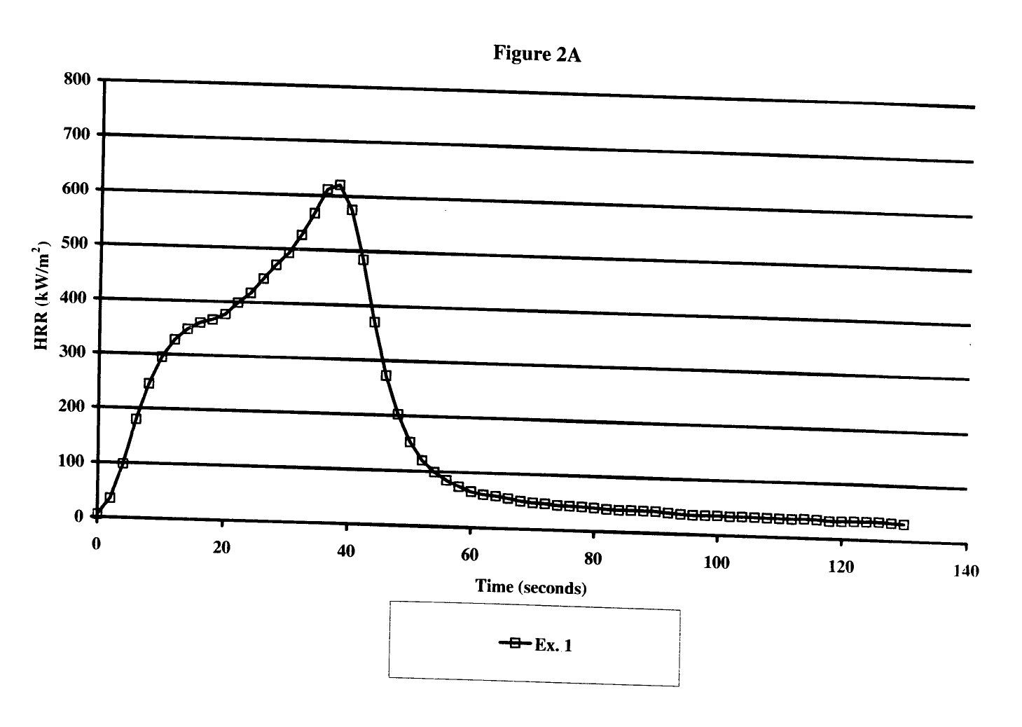

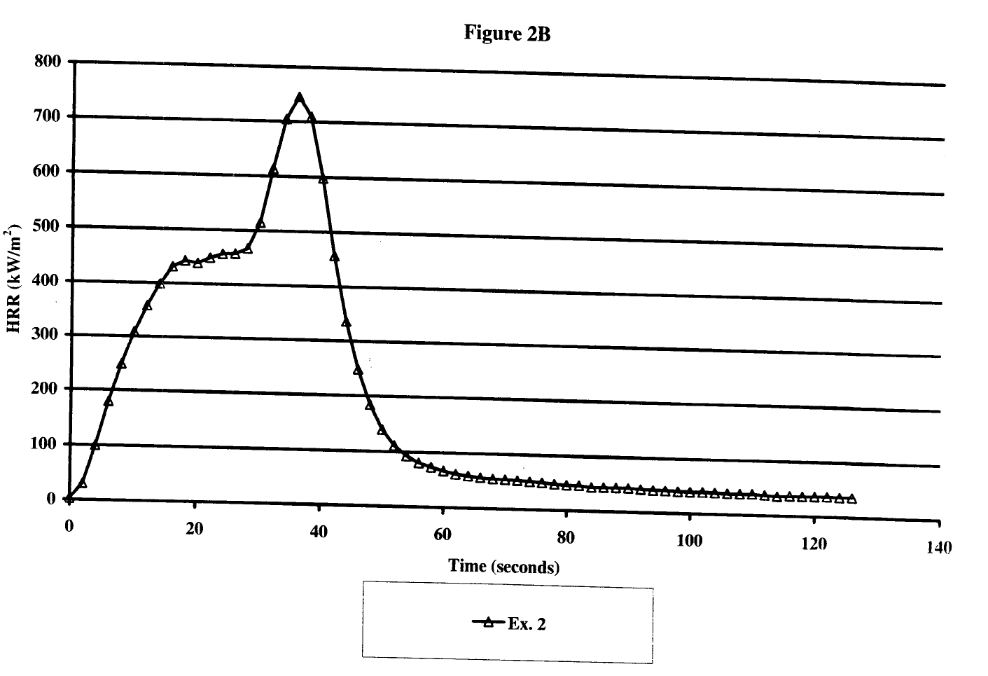

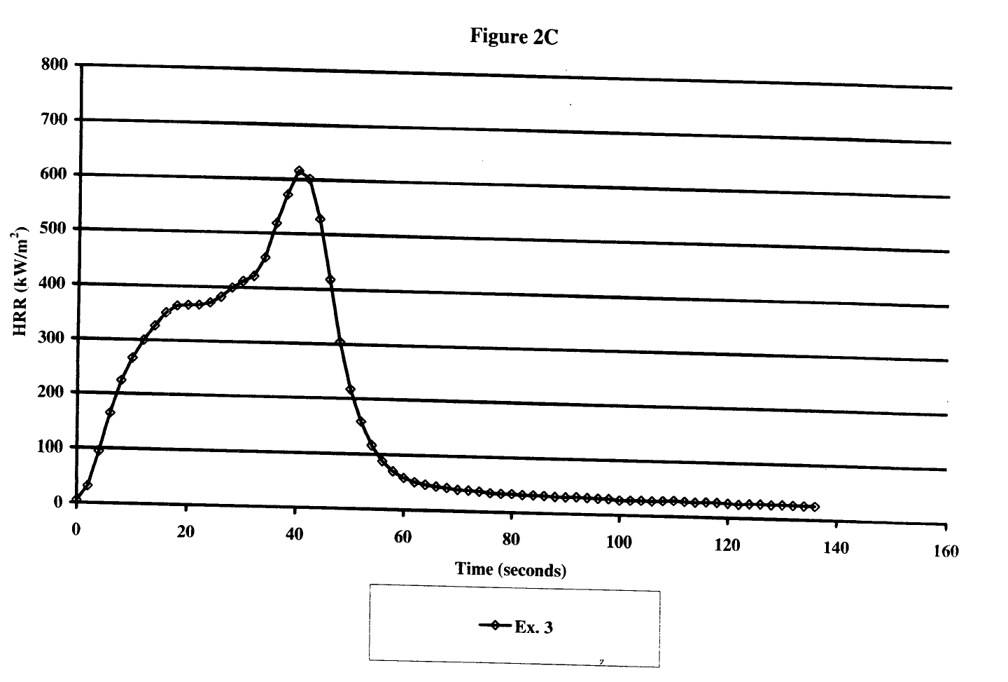

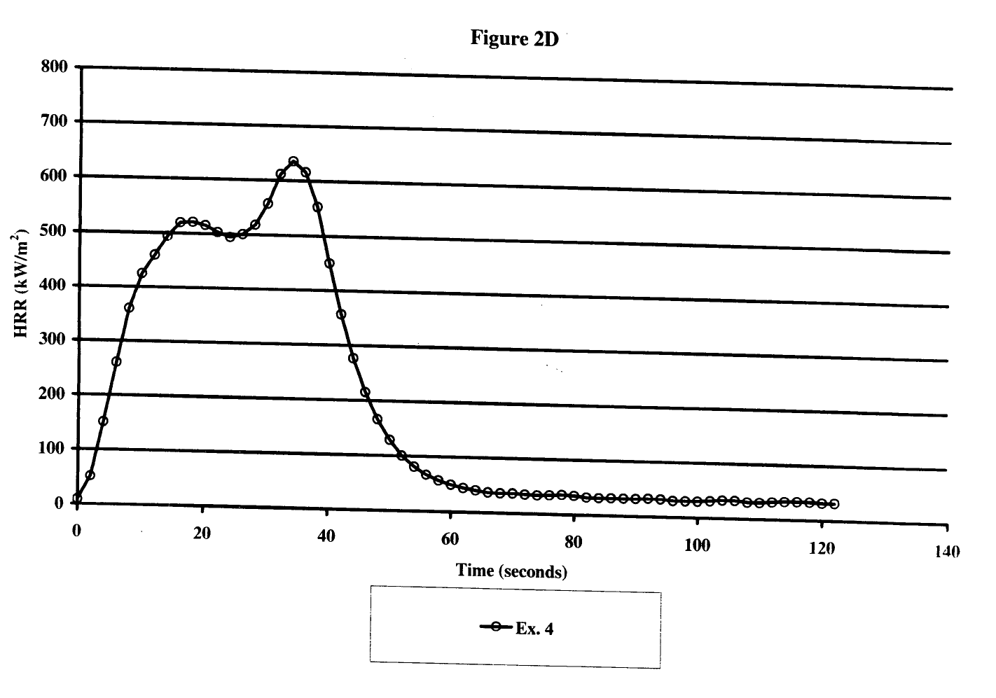

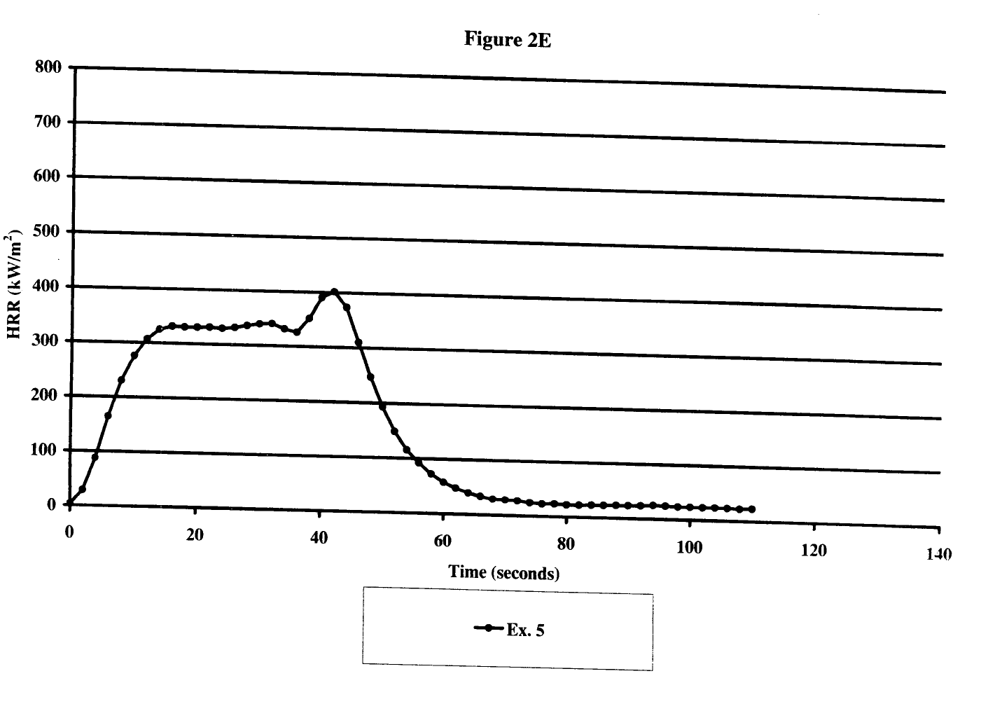

The foams made in these examples were tested using the UL 94V test and the foam of Example 5 passed with a rating of V-1. The foams of the examples were also subjected to cone calorimetry analysis—a small scale burn test which evaluates with high precision the heat release rates and smoke generation (specific extinction area) generated over time as well as other burn characteristics not monitored for this application, and the results of the specific extinction area (FIG. 1) and heat release rate (FIG. 2) confirmed the UL 94V test result.

TABLE I

| Component | Ex. 1 | Ex. 2 | Ex. 3 | Ex. 4 | Ex. 5 |
|---|---|---|---|---|---|
| POLYOL A | 50.00 | 50.00 | 50.00 | 20.00 | 20.00 |
| POLYOL B | 35.00 | 35.00 | 35.00 | 35.00 | 35.00 |
| POYOL C | — | — | — | 30.00 | 30.00 |
| CHAIN EXTENDER | 15.00 | 15.00 | 15.00 | 15.00 | 15.00 |
| COMPATIBILIZER | 6.00 | 6.00 | 6.00 | 6.00 | 6.00 |
| SURFACTANT | 2.00 | 2.00 | 2.00 | 2.00 | 2.00 |
| BLOWING AGENT | 0.50 | 0.50 | 0.50 | 0.50 | 0.50 |
| WATER | 2.75 | 2.75 | 2.75 | 2.75 | 2.75 |
| FLAME | 10.00 | 15.00 | 20.00 | — | 20.00 |
| RETARDANT A | | | | | |
| FLAME | 10.00 | 10.00 | 10.00 | — | 10.00 |
| RETARDANT B | | | | | |
| CATALYST A | 0.09 | 0.09 | 0.09 | 0.09 | 0.09 |
| CATALYST B | 0.50 | 0.50 | 0.50 | 0.50 | 0.50 |
| ISOCYANATE B | 137.4 | 137.4 | 137.4 | 150.3 | 150.3 |

### Examples C6 and 7-9

The components were combined in the amounts given in Table II below and reacted at an isocyanate index of 120 to produce foam samples having a molded density of 6 pcf. The control (Ex. C-6) for this set of examples used a two-phase stable polyol blend. Although physical property performance of the resultant foam was good, a one-phase blend was desired for easier, long term handling in outside field conditions.

The blend was made phase stable by replacing portions of Chain Extender (viscosity is 14 cps) and Polyol A (viscosity is 850 cps) with Crosslinking Agent (viscosity is 1,400 cps) by weight. After the blend was phase stable, the same water and catalyst concentrations previously used by the control were now evaluated in these systems.

TABLE II

| Component | Ex. C-6 | Ex. 7 | Ex. 8 | Ex. 9 |
|---|---|---|---|---|
| POLYOL A | 50 | 20 | 35 | 5 |
| POLYOL B | 35 | 35 | 35 | 35 |
| POLYOL C | — | 30 | — | 30 |
| FLAME RETARDANT A | — | 20 | — | 20 |
| FLAME RETARDANT B | — | 10 | — | 10 |
| CHAIN EXTENDER | 15 | 15 | 10 | 10 |
| CROSS LINKING AGENT | — | — | 15 | 15 |
| COMPATIBILIZER | 6 | 6 | 6 | 6 |
| WATER | 2.75 | 2.75 | 2.75 | 2.75 |
| SURFACTANT | 2 | 2 | 2 | 2 |
| BLOWING AGENT | 0.5 | 0.5 | 0.5 | 0.5 |
| CATALYST B | 0.5 | 0.5 | 0.5 | 0.5 |
| CATALYST A | 0.09 | 0.09 | 0.09 | 0.09 |
| ISOCYANATE A | 159.2 | — | 145.4 | — |
| ISOCYANATE B | — | 150.3 | — | 138.3 |

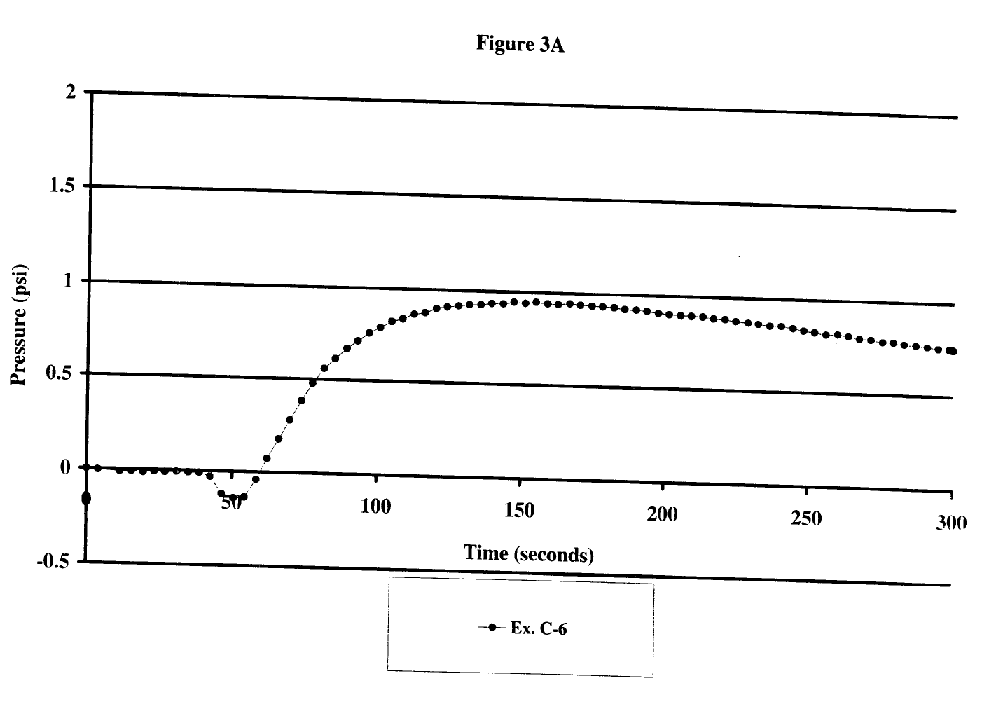

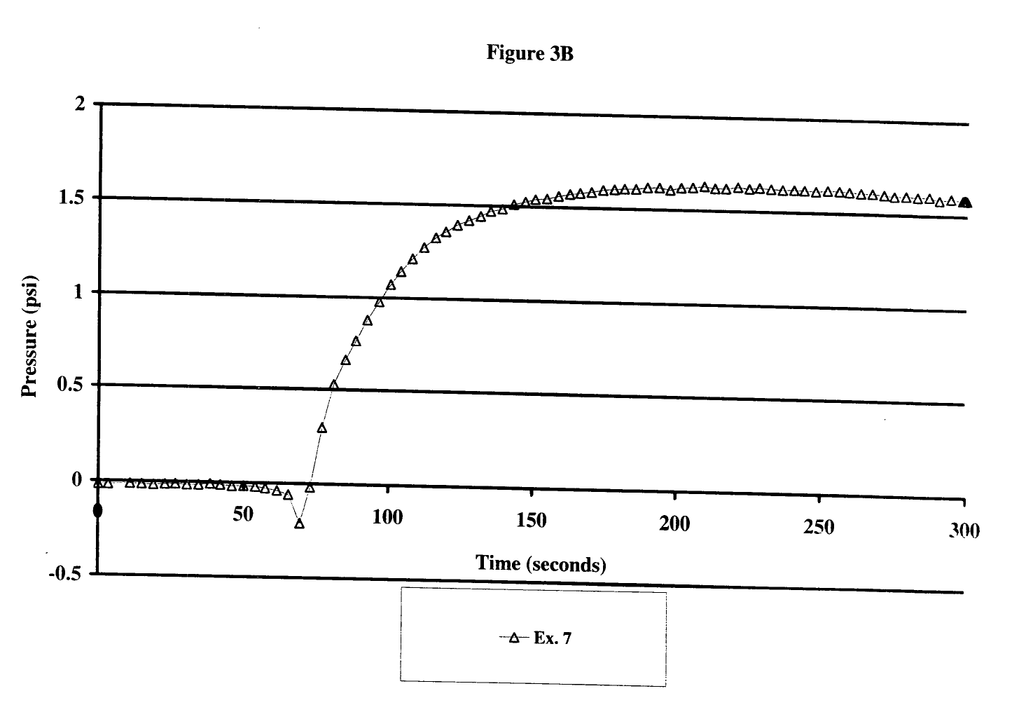

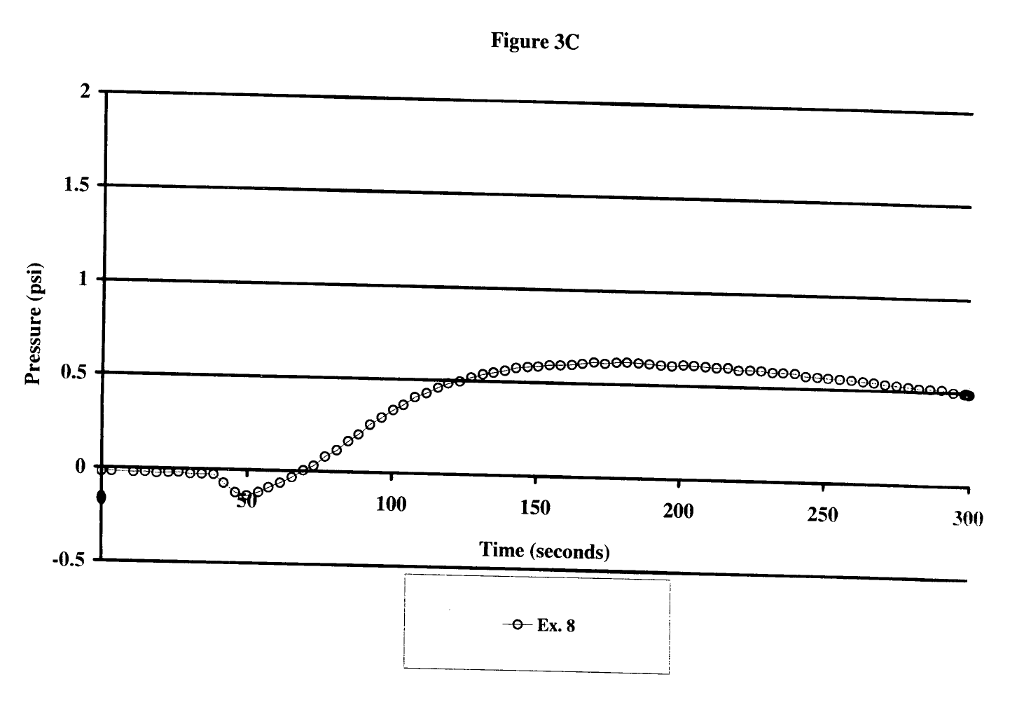

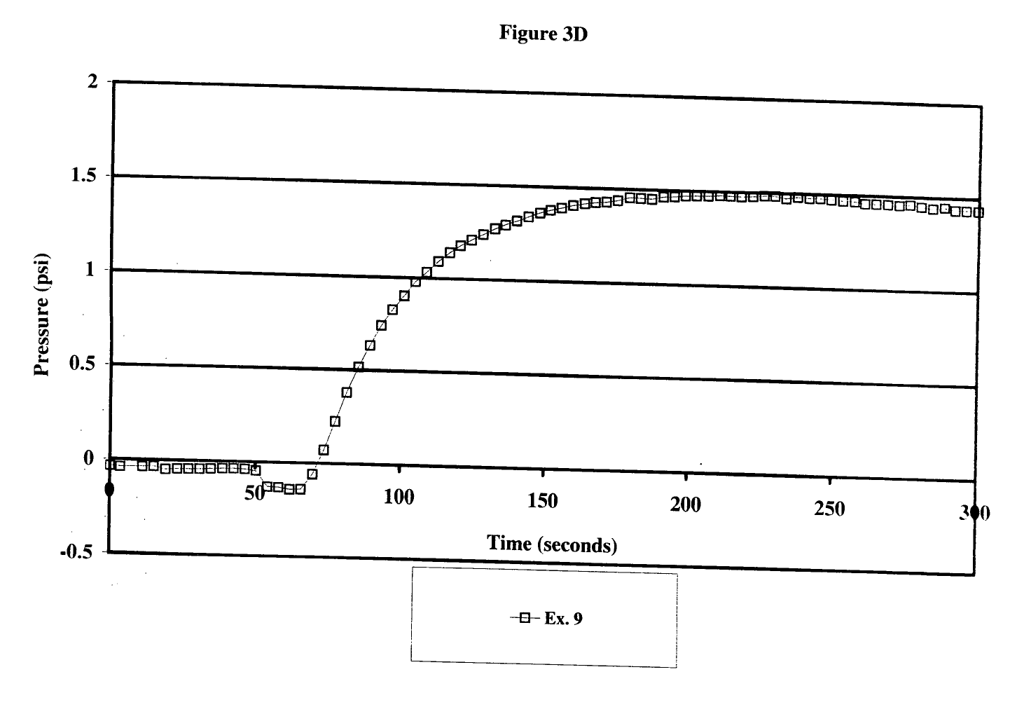

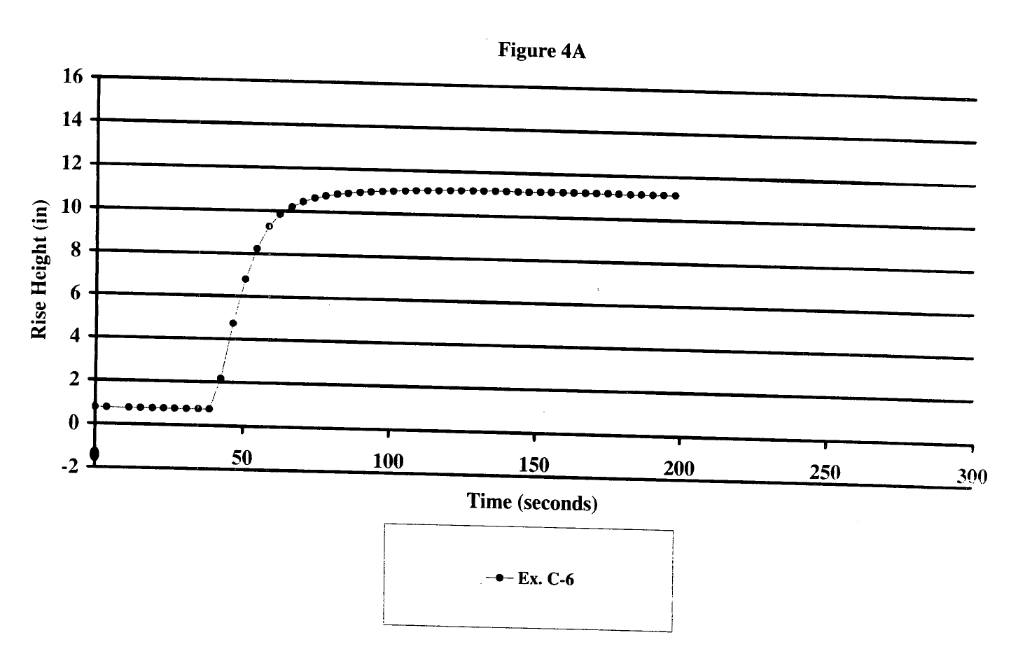

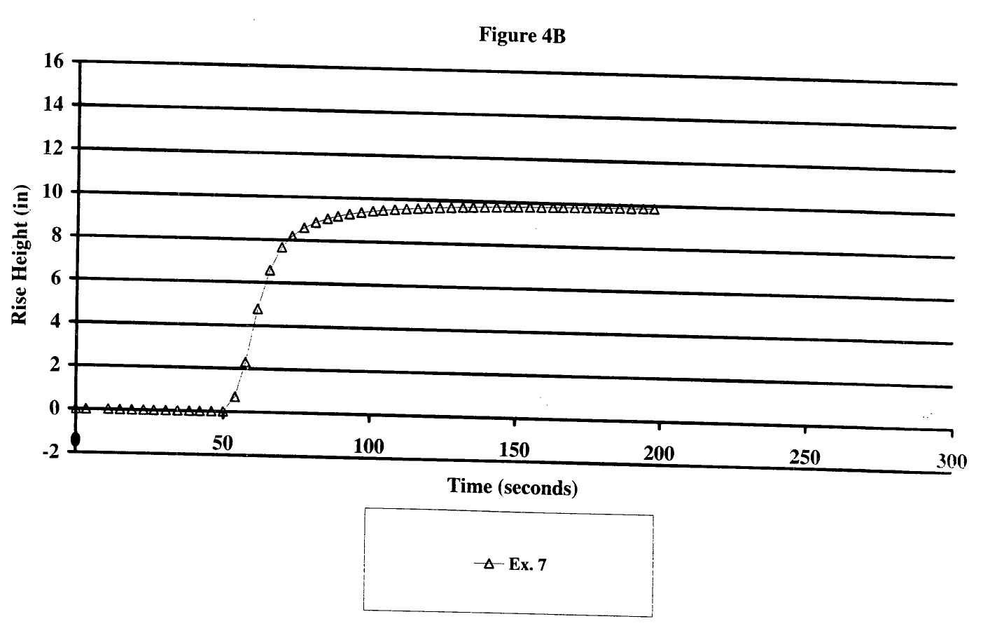

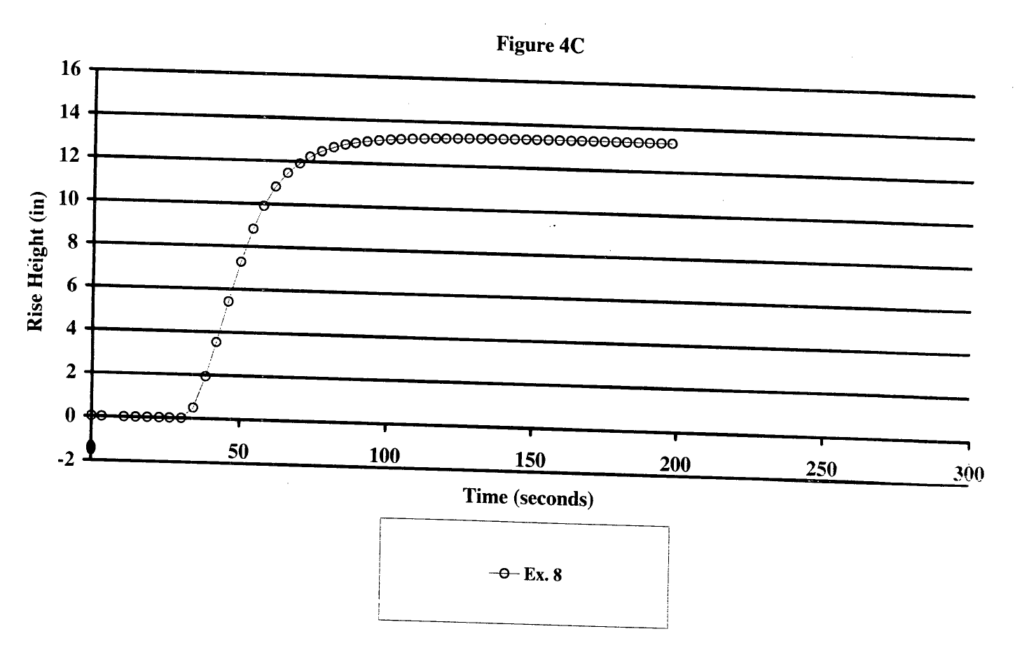

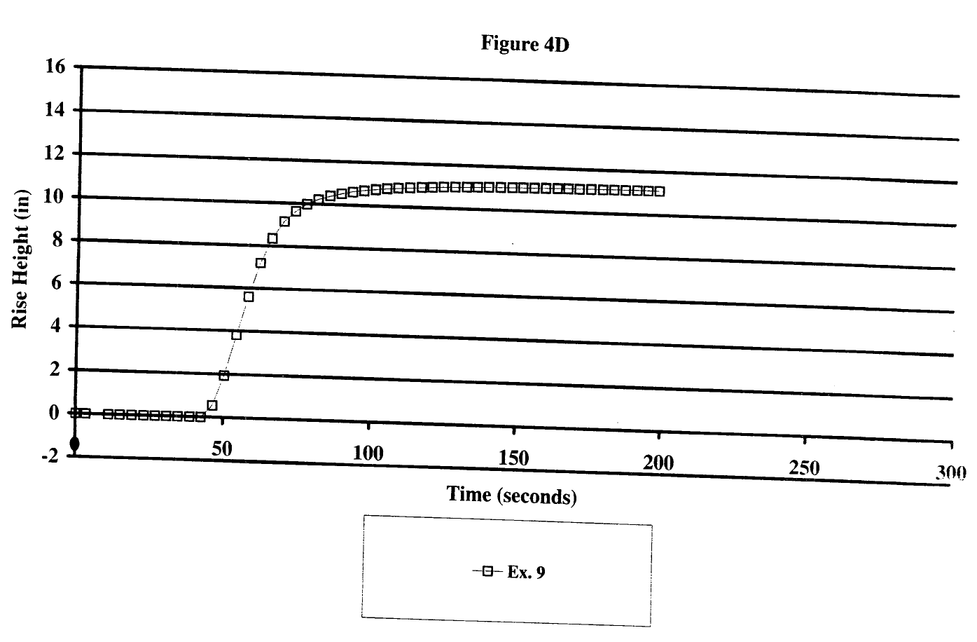

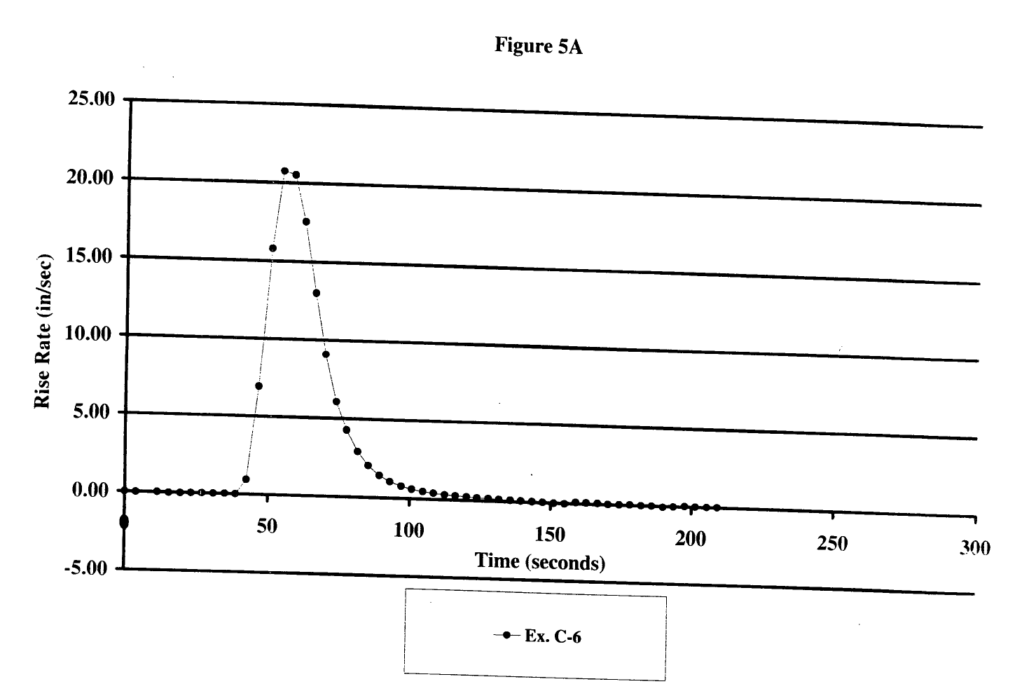

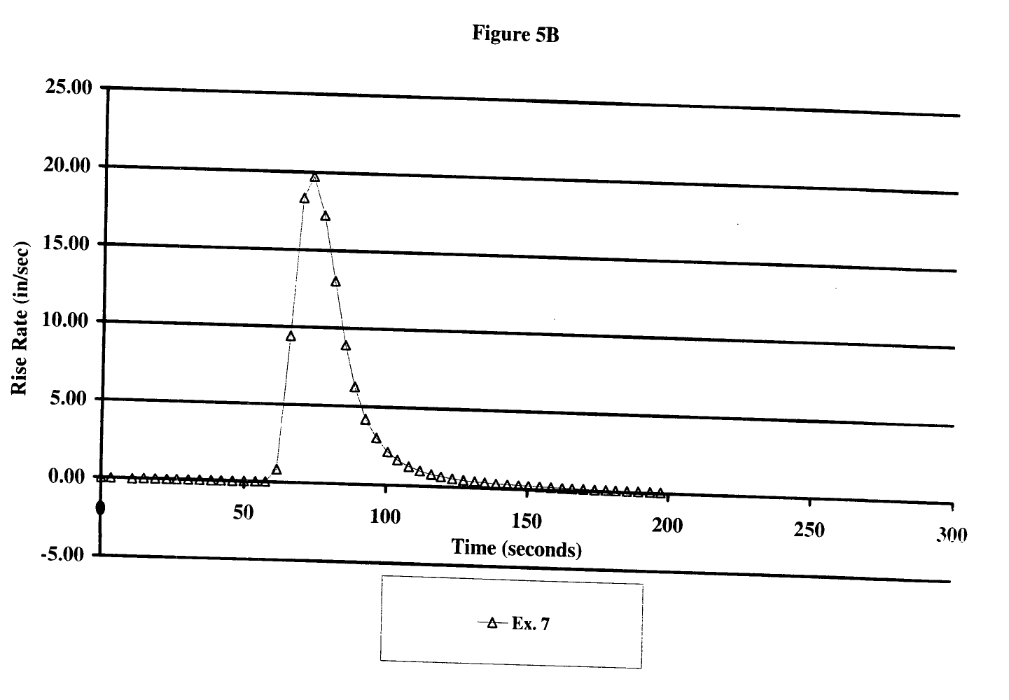

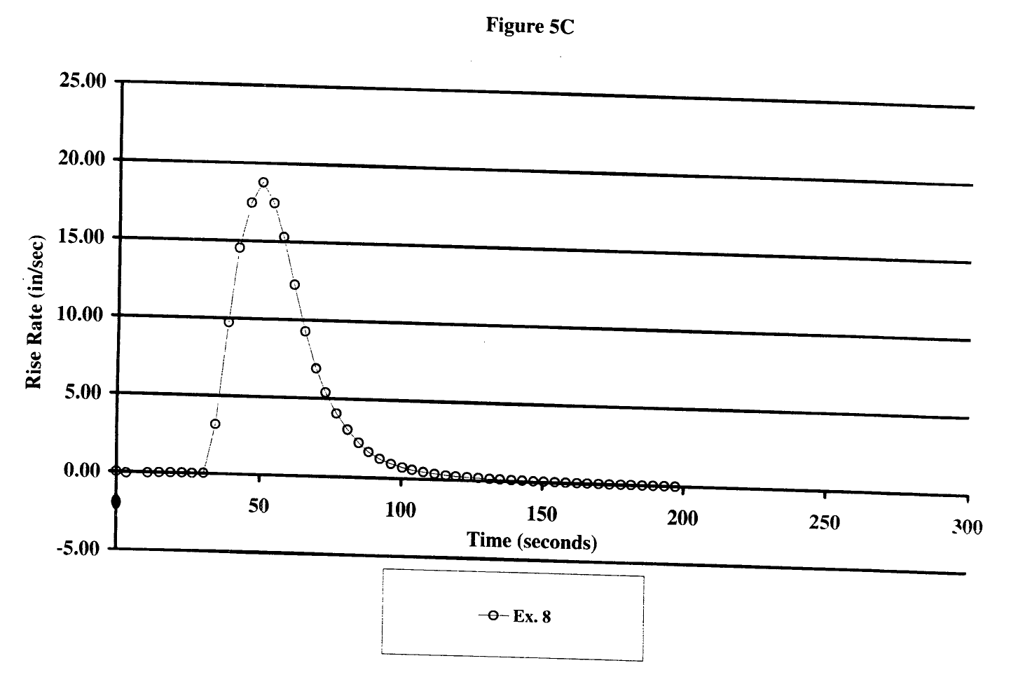

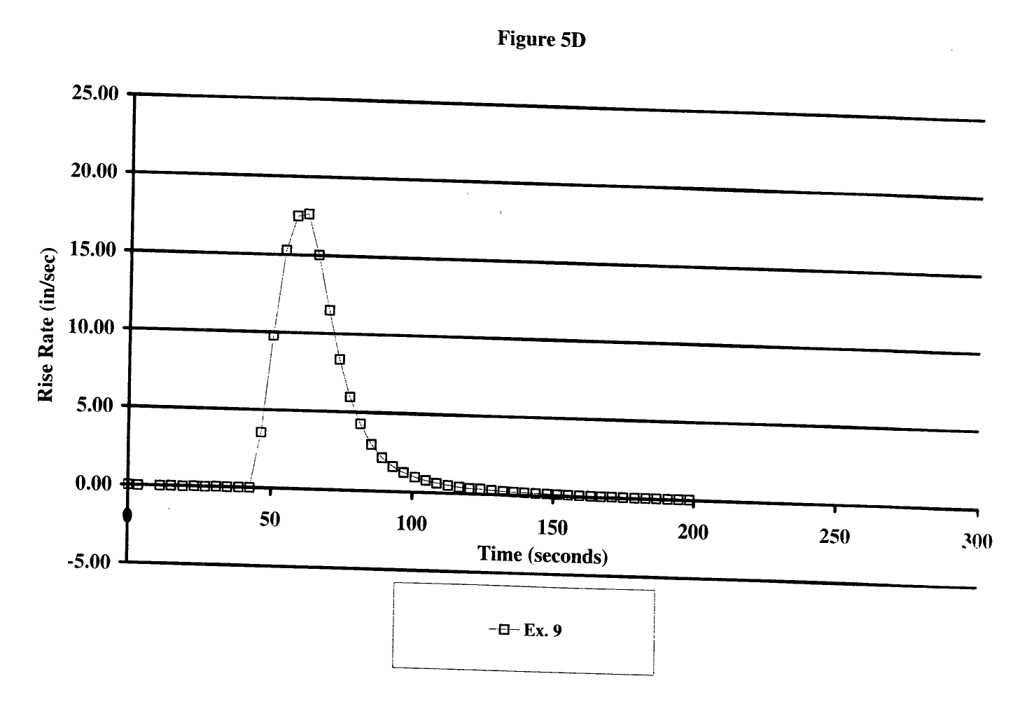

A FLUIDYNE (originally ASTM D2237) was used to provide instrumental determination of various characteristics of foaming materials and a Brookfield Rheometer R/S was used to characterize resin blend viscosity. The present inventors discovered that although the reaction profile in the hand mixes and water measurements indicated that the blends were similar, the viscosities were reduced (Table IV) and internal molding pressures (FIG. 3) were found to be much lower in the new one phase blends. The rise height or maximum flow height of the foam was found to be higher (larger than experimental error) than the control (FIG. 4). The reaction rate (FIG. 5) of the blends, however, remained comparable. This was not expected.

Table III below provides processing details for the foams; of particular note is the phase stability of the formulations after one week. As can be appreciated by reference to Table III, the blends of Examples 8 and 9 retained their one phase character after one week, whereas the blends of Comparative Example 6 and Example 7 separated into two distinct phases. Phase stability is important in the context of using the inventive foams to produce barriers because it insures optimum compatibility and mix which more easily guarantees maximum reaction performance and ultimately maximum physical property performance.

TABLE III

| Processing Details | Ex. C-6 | Ex. 7 | Ex. 8 | Ex. 9 |
|---|---|---|---|---|
| Ratio A/100B | 142 | 106 | 136 | 101 |
| Index | 120 | 120 | 120 | 120 |
| Cream Time (sec) | 24 | 26 | 24 | 23 |
| Gel Time (sec) | 53 | 52 | 57 | 55 |
| Tack Free Time (sec) | 65 | 74 | 87 | 86 |
| Free Rise Density (pcf) | 3.61 | 3.94 | 3.11 | 3.65 |
| Panel Density (pcf) | 6 | 6 | 6 | 6 |
| Phase Stability after one | was cloudy, | polyol was | polyol was | polyol was |
| week | formulation is | clear and | clear and in | cloudy and in |
| | known to | separated | one phase | one phase, |
| | separate into | into two | | no separation |
| | two phases | phases | | visible |

Table IV below provides viscosity measurements of the various polyol component blends from Table II over a range of four temperatures. As can be appreciated from Table IV below, the polyol component included in the inventive foams has a much lower viscosity than the Comparative Example C-6 at every temperature observed. This lowered viscosity provides for increased foam flow efficiency while reducing internal blowing pressure, thus allowing for the inventive foam to be used to quickly fill, for example, an inflatable, to produce a rapidly erected, lightweight barrier against hazards such as chemicals, fire, and adversarial hand held equipment attacks. A suitable inflatable for producing such lightweight barriers is described in U.S. Pat. No. 3,670,504. Barriers made from the inventive foams may also be used to maintain control of access to areas that have been secured.

TABLE IV

| | Ex. C-6 | Ex. 7 | | |
|---|---|---|---|---|
| | Viscosity | Viscosity | Ex. 8 | Ex. 9 |
| Temp. (° F.) | (cps) | (cps) | Viscosity (cps) | Viscosity (cps) |
| 20 | 7350 | 3860 | 4850 | 1965 |
| 75 | 1050 | 570 | 850 | 480 |
| 95 | 670 | 348 | 468 | 245 |
| 140 | 142.5 | 95 | 112.5 | 67.5 |

The low density, semi-rigid polyurethane foams made in the above examples were subjected to physical property testing as follows: Density (ASTM D1622); Flexural modulus and strength (ASTM D790): Charpy Impact (ASTM D6110); Heat Sag (ASTM D3769); Compression Set (ASTM D-395); Taber Abrasion (ASTM D-4060) and UL 94 V Flammability. The results of those physical property tests are presented below in Table V. As can be appreciated by reference to Table V, physical properties of the foams are comparable between Comparative Example C-6 and Example 8 as are those with flame retardant(s) added to both these chemistries in Example 7 and Example 9. With the flame retardant added, an increase in Taber Abrasion numbers is observed due to the plasticizing effect of the flame retardant, but this is expected and holds true with Example 7 and Example 9 as well. No foam property losses were seen. The main advantage in physical property performance observed and unexpected is the flame resistance possible with the new one phase chemistry.

TABLE V

| Average Physical | | | | |
|---|---|---|---|---|
| Testing Details | C-6 | Ex. 7 | Ex. 8 | Ex. 9 |
| Thickness (in.) | 0.5 | 0.5 | 0.5 | 0.5 |
| Density (lb/ft³) | 5.5 | 6.0 | 5.2 | 6.3 |
| Flex Modulus (psi) | 4,025 | 2,491 | 3,126 | 4,215 |
| Flex Strength (psi) | 123 | 82 | 97 | 118 |
| Charpy Impact | 2 | 1.1 | 0.9 | 1 |
| (ft · lbf/in²) | | | | |
| Comment on Charpy | all partial | all partial | all hinge | one complete |
| Impact test | breaks | breaks | breaks | break, |
| | | | | others were |
| | | | | hinge breaks |
| Heat Sag | 49.3 | 46.0 | 47.8 | 49.3 |
| at 6 in. overhang, | | | | |
| 250° F., 1 hour (mm) | | | | |
| Compression Set | 94 | 102 | 92 | 97 |
| at 25% Deflection (%) | | | | |
| Taber Abrasion, | 2,018 | 4,093 | 2,957 | 4,988 |
| H-18 Wheel, | | | | |
| mg/1000 cycles (mg) | | | | |
| UL 94 V Flammability | Fail | V-1 | Fail | V-1 |

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A low density, semi-rigid polyurethane loam comprising the reaction product, at an isocyanate index of from about 100 to about 150, of:
at least one polyisocyanate; and
an isocyanate-reactive blend comprising,
from about 15 wt. % to about 55 wt. %. based on the weight of the resin, of a difunctional or greater functionality polyether polyol,
from about 3 wt. % to about 19 wt. %, based on the weight of the resin, of at least one polyether tetrol, and
from about 7 wt. % to about 39 wt. %, based on the weight of the resin, of at least one non-halogenated polyester polyol;
in the presence of from about 5 wt. % to about 30 wt. % , based on the weight of the resin, of at least one non-hydroxy functional flame retardant and from about 1 wt. % to about 20 wt. % , based on the weight of the resin, of at least one cross linking agent,
and optionally in the presence of one or more of catalysts, surfactants, chain extenders and blowing agents,
wherein the semi-rigid polyurethane foam having a density of from about 2 to about 25 pcf meets at least a V-J class rating in accordance with UL 94 V flammability testing.

2. The low density, semi-rigid polyurethane foam according to claim 1, wherein the at least one polyisocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-and -1,4-diisocyanate, 1-isocyanato-3,3,5-trimethyl-5-isocyanatomethyl-cyclohexane (isophorone diisocyanate), 2,4- and 2,6-hexahydrotoluene diisocyanate, dicyclohexylmethane-4,4′-diisocyanate (hydrogenated MDI, or HMDI), 1,3- and 1,4-phenylene diisocyanate, 2,4- and 2,6-toluene diisocyanate (TDI), diphenylmethane-2,4′- and/or -4,4′-diisocyanate (MDI), naphthylene-1,5-diisocyanate, triphenyl-methane-4,4′,4″-triisocyanate, polyphenyl-polymethylene-polyisocyanates (crude MDI), norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret containing polyisocyanates, isocyanate-terminated prepolymers and mixtures thereof.

3. The low density, semi-rigid polyurethane foam according to claim 1, wherein the at least one non-hydroxy functional flame retardant is selected from the group consisting of phosphonates, phosphites, phosphates, halogen-containing compounds, melamine, expanded graphite, antimony oxides, zinc compounds, aluminum compounds, magnesium compounds and mixtures thereof.

4. The low density, semi-rigid polyurethane foam according to claim 1, wherein the non-hydroxy functional flame retardant comprises from about 5 wt. % to about 20 wt. %, based on the weight of the resin.

5. The low density, semi-rigid polyurethane foam according to claim 1, wherein the at least one non-halogenated polyester polyol comprises from about 7 wt. % to about 21 wt. %, based on the weight of the resin.

6. The low density, semi-rigid polyurethane foam according to claim 1, wherein the at least one cross linking agent comprises from about 5 wt. % to about 15 wt. %, based on the weight of the resin.

7. The low density, semi-rigid polyurethane foam according to claim 1, wherein the difunctional or greater functionality polyether polyol comprises from about 11 wt. % to about 53 wt. %, based on the weight of the resin.

8. The low density, semi-rigid polyurethane foam according to claim 1, wherein the polyether tetrol comprises from about 5 wt. % to about 14 wt. %, based on the weight of the resin.

9. The low density, semi-rigid polyurethane foam according to claim 1 having a density of from about 4 to about 15 pcf.

10. The low density, semi-rigid polyurethane foam according to claim 1, wherein the blowing agent is selected from the group consisting of water, acetone, ethyl acetate, methanol, ethanol, butane, carbon dioxide, hexane, heptane, fluorocarbons, chlorofluorocarbons, hydrochlorofluorocarbons, methylene chloride, chloroform, ethyl idene chloride, vinyl idene chloride, monofluorotrichloromethane, chlorodifluoroethane, dichlorodifluoromethane, diethylether, lactic acid, citric acid, malonic acid and mixtures thereof.

11. A rapidly erectable, lightweight barrier comprising a low density, semi-rigid polyurethane foam comprising the reaction product, at an isocyanate index of from about 100 to about 150, of:
at least one polyisocyanate; and
an isocyanate-reactive blend comprising,
from about 15 wt. % to about 55 wt. %, based on the weight of the resin, of a difunctional or greater functionality polyether polyol,
from about 3 wt. % to about 19 wt. %, based on the weight of the resin, of at least one polyether tetrol, and
from about 7 wt. % to about 39 wt. %, based on the weight of the resin, of at least one non-halogenated polyester polyol;
in the presence of from about 5 wt. % to about 30 wt. %, based on the weight of the resin, of at least one non-hydroxy functional flame retardant and from about 1 wt. % to about 20 wt. %, based on the weight of the resin, of at least one cross linking agent.
and optionally in the presence of one or more of catalysts, surfactants, chain extenders and blowing agents,
wherein the semi-rigid polyurethane foam having a density of from about 2 to about 25 pcf meets at least a V-1 class rating in accordance with UL 94 V flammability testing.

12. A process for the production of a low density, semi-rigid polyurethane foam comprising reacting, at an isocyanate index of from about 100 to about 150:
at least one polyisocyanate; and
an isocyanate-reactive blend comprising,
from about 15 wt. % to about 55 wt. %, based on the weight of the resin, of a difunctional or greater functionality polyether polyol,
from about 3 wt. % to about 19 wt. %, based on the weight of the resin, of at least one polyether tetrol, and
from about 7 wt. % to about 39 wt. %, based on the weight of the resin, of at least one non-halogenated polyester polyol;
in the presence of from about 7 wt. % to about 30 wt. %, based on the weight of the resin, of at least one non-hydroxy functional flame retardant and from about 1 wt. % to about 20 wt. %, based on the weight of the resin, of at least one cross linking agent,
and optionally in the presence of one or more of catalysts, surfactants, chain extenders and blowing agents,
wherein the low density, semi-rigid polyurethane foam with a density of from about 2 to about 25 pcf meets at least a V-1 class rating in accordance with UL 94 V flammability testing.

13. The process according to claim 12, wherein the at least one polyisocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-and -1,4-diisocyanate, 1-isocyanato-3,3,5-trimethyl-5-isocyanatomethyl-cyclohexane(isophorone diisocyanate), 2,4- and 2,6-hexahydrotoluene diisocyanate, dicyclohexylmethane-4,4′-diisocyanate (hydrogenated MDI, or HMDI), 1,3- and 1,4-phenylene diisocyanate, 2,4- and 2,6-toluene diisocyanate (TDI), diphenylmethane-2,4′- and/or -4,4′-diisocyanate (MDI), naphthylene-1,5-diisocyanate, triphenyl-methane-4,4′,4″-triisocyanate, polyphenyl-polymethylene-polyisocyanates (crude MDI), norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret containing polyisocyanates, isocyanate-terminated prepolymers and mixtures thereof.

14. The process according to claim 12, wherein the at least one non-hydroxy functional flame retardant is selected from the group consisting of phosphonates, phosphites, phosphates, halogen-containing compounds, melamine, expanded graphite, antimony oxides, zinc compounds, aluminum compounds, magnesium compounds and mixtures thereof.

15. The process according to claim 12, wherein the non-hydroxy functional flame retardant comprises from about 5 wt. % to about 20 wt. %, based on the weight of the resin.

16. The process according to claim 12, wherein the at least one non-halogenated polyester polyol comprises from about 7 wt. % to about 21 wt. %, based on the weight of the resin.

17. The process according to claim 12, wherein the at least one cross linking agent comprises from about 5 wt. % to about 15 wt. %, based on the weight of the resin.

18. The process according to claim 12, wherein the difunctional or greater functionality polyether polyol comprises from about 11 wt. % to about 53 wt. %, based on the weight of the resin.

19. The process according to claim 12, wherein the polyether tetrol comprises from about 5 wt. % to about 14 wt. %, based on the weight of the resin.

20. The process according to claim 12, wherein the blowing agent is selected from the group consisting of water, acetone, ethyl acetate, methanol, ethanol, butane, carbon dioxide, hexane, heptane, fluorocarbons, chlorofluorocarbons, hydrochlorofluorocarbons, methylene chloride, chloroform, ethyl idene chloride, vinyl idene chloride, monofluorotrichloromethane, chlorodifluoroethane, dichlorodifluoromethane, diethylether, lactic acid, citric acid, malonic acid and mixtures thereof.

21. The process according to claim 12, wherein the low density, semi-rigid polyurethane foam has a density of from about 4 to about 15 pcf.

22. A method of delaying pursuit by one or more adversaries, the method comprising erecting a barrier comprising a low density, semi-rigid polyurethane foam comprising the reaction product, at an isocyanate index of from about 100 to about 150, of at least one polyisocyanate and an isocyanate-reactive blend comprising from about 15 wt. % to about 55 wt. %, based on the weight of the resin, of a difunctional or greater functionality polyether polyol, from about 3 wt. % to about 19 wt. %, based on the weight of the resin, of at least one polyether tetrol, and from about 7 wt. % to about 39 wt. % , based on the weight of the resin, of at least one non-halogenated polyester polyol, in the presence of from about 5 wt. % to about 30 wt. % , based on the weight of the resin, of at least one non-hydroxy functional flame retardant and from about 1 wt. % to about 20 wt. %, based on the weight of the resin, of at least one cross linking agent, and optionally in the presence of one or more of catalysts, surfactants, chain extenders and blowing agents, wherein the semi-rigid polyurethane foam having a density of from about 2 to about 25 pcf meets at least a V-1 class rating in accordance with UL94 V flammability testing.

23. A method of limiting access to a secured area comprising erecting one or more barriers comprising a low density, semi-rigid polyurethane foam comprising the reaction product, at an isocyanate index of from about 100 to about 150, of at least one polyisocyanate and an isocyanate-reactive blend comprising from about 15 wt. % to about 55 wt. %, based on the weight of the resin, of a difunctional or greater functionality polyether polyol, from about 3 wt. % to about 19 wt. %, based on the weight of the resin, of at least one polyether tetrol, and from about 7 wt. % to about 39 wt. %, based on the weight of the resin, of at least one non-halogenated polyester polyol, in the presence of from about 5 wt. % to about 30 wt. %, based on the weight of the resin, of at least one non-hydroxy functional flame retardant and from about 1 wt. % to about 20 wt. %, based on the weight of the resin, of at least one cross linking agent, and optionally in the presence of one or more of catalysts, surfactants, chain extenders and blowing agents, wherein the semi-rigid polyurethane foam having a density of from about 2 to about 25 pcf meets at least a V-1 class rating in accordance with UL 94 V flammability testing.
